(19) United States
(12) Patent Application Publication
(10) Pub. No.: US 2024/0227141 A1
(43) Pub. Date: Jul. 11, 2024

(54) RETAINING RING PLIER SYSTEMS, METHODS, AND APPARATUS

(71) Applicant: Tiger Tool International Incorporated, Abbotsford (CA)

(72) Inventor: Rudolf Maksymilian Klossok, Coquitlam (CA)

(73) Assignee: Tiger Tool International Incorporated, Abbotsford (CA)

(21) Appl. No.: 18/406,555

(22) Filed: Jan. 8, 2024

Related U.S. Application Data
(60) Provisional application No. 63/478,920, filed on Jan. 7, 2023.

(51) Int. Cl. B25B 27/20

(52) U.S. Cl. CPC B25B 27/205

(57) ABSTRACT

A retaining ring plier comprises a drive system. a first tip, a second tip, and a linkage system. The drive system defines a drive axis and comprises a base member defining a base drive opening, a carrier member defining a carrier drive opening, and a drive rod defining first and second surface portions, where the drive rod is arranged such that the first surface portion engages the base drive opening and the second surface portion engages the carrier drive opening. The linkage system comprises first drive link member extending between the carrier member and the first tip, a second drive link member extending between the carrier member and the second tip, at least one first guide link member extending between the base member and the first tip. The at least one second guide link member extends between the base member and the second tip.

### RELATED APPLICATIONS

This application (Attorney's Ref. No. P220472) claims benefit of U.S. Provisional Application Ser. No. 63/478,920 filed Jan. 7, 2023, the contents of which are incorporated herein by reference.

### TECHNICAL FIELD

The present invention relates to the installation and removal of retaining rings and, more specifically, to plier systems configured to facilitate the installation and/or removal of retaining rings.

### BACKGROUND

Retaining rings are commonly used to maintain a part within a recess. The retaining ring is resiliently deformable. A retaining groove is formed in the recess, and the part is inserted into the recess past the groove. The retaining ring is deformed to a compressed configuration such that the retaining ring may be inserted into the recess aligned with the retaining groove. The retaining ring is then allowed to expand to an expanded configuration such that the retaining ring is at least partly received within the retaining groove. With the retaining ring at least partly received within the retaining groove in the expanded configuration, at least a portion of the retaining ring engages the part to inhibit removal of the part from the recess. To remove the part from the recess, the retaining ring is deformed from the expanded configuration to the compressed configuration and removed from the retaining groove.

The need exists for improved systems and methods for deforming retaining rings between the expanded configuration and the compressed configuration to facilitate installation and removal of such retaining rings.

### SUMMARY

The present invention may be embodied as a retaining ring plier comprising a drive system, a first tip, a second tip, and a linkage system. The drive system defining a drive axis and comprises a base member defining a base drive opening, a carrier member defining a carrier drive opening, and a drive rod defining first and second surface portions, where the drive rod is arranged such that the first surface portion engages the base drive opening and the second surface portion engages the carrier drive opening. The linkage system comprises a first drive link member extending between the carrier member and the first tip, a second drive link member extending between the carrier member and the second tip, at least one first guide link member extending between the base member and the first tip, and at least one second guide link member extending between the base member and the second tip. Axial rotation of the drive rod in a first rotation direction displaces the carrier member in a first drive direction relative to the base member. Displacement of the carrier member in the first drive direction displaces, through the first and second drive links, the first and second tips in a first tip direction relative to each other. The at least one first guide link and the at least one second guide link support the first and second tip assemblies to maintain a desired angular relationship between the first and second tips as the first and second tips are displaced relative to each other through the first and second drive links.

The present invention may also be embodied as a method of installing retaining ring comprising the following steps. A drive system defining a drive axis, first tip, second tip, and linkage system are provide. The drive system defines a drive axis and comprises a base member defining a base drive opening, a carrier member defining a carrier drive opening, and a drive rod defining first and second surface portions, where the drive rod is arranged such that the first surface portion engages the base drive opening and the second surface portion engages the carrier drive opening. The linkage system comprises a first drive link member, a second drive link member, at least one first guide link member, and at least one second guide link member. The first drive link member is extended between the carrier member and the first tip. The second drive link member is extended between the carrier member and the second tip. Thye at least one first guide link member is arranged to extend between the base member and the first tip. The at least one second guide link member is arranged to extend between the base member and the second tip. The drive rod is axially rotated in a first rotation direction to displace the carrier member in a first drive direction relative to the base member such that displacement of the carrier member in the first drive direction displaces, through the first and second drive links, the first and second tips in a first tip direction relative to each other. The at least one first guide link and the at least one second guide link are arranged to support the first and second tip assemblies such that a desired angular relationship is maintained between the first and second tips as the first and second tips are displaced relative to each other through the first and second drive links.

The present invention may also be embodied as a retaining ring plier comprising a drive system driving a drive axis, first and second tips, and a linkage system. The drive system comprises a base member defining a base drive opening, a carrier member defining a carrier drive opening, and a drive rod defining first and second surface portions, where the drive rod is arranged such that the first surface portion engages the base drive opening and the second surface portion engages the carrier drive opening. The linkage system comprises a first drive link member extending between the carrier member and the first tip, a second drive link member extending between the carrier member and the second tip, a pair of first guide link members extending between the base member and the first tip, and a pair of second guide link members extending between the base member and the second tip. Axial rotation of the drive rod in a first rotation direction displaces the carrier member in a first drive direction relative to the base member. Displacement of the carrier member in the first drive direction displaces, through the first and second drive links, the first and second tips in a first tip direction relative to each other. The pair of first guide links and the pair of second guide links support the first and second tip assemblies to maintain a desired angular relationship between the first and second tips as the first and second tips are displaced relative to each other through the first and second drive links.

### BRIEF DESCRIPTION OF THE DRAWINGS

FIG. 1 is a perspective view of a first example retaining ring plier of the present invention;

FIG. 2 is a perspective view of a retaining ring of the type installed and/or removed by the first example retaining ring plier;

FIG. 3 is a front elevation view of the first example retaining ring plier in a first configuration and operated to define a first spacing distance;

FIG. 4 is a front elevation view of the first example retaining ring plier in the first configuration and operated to define a second spacing distance;

FIG. 5 is a first side elevation view of the first example retaining ring plier;

FIG. 6 is a second side elevation view of the first example retaining ring plier;

FIG. 7 is a section view taken along lines 7-7 in FIG. 3;

FIG. 8 is a section view taken along lines 8-8 in FIG. 5;

FIG. 9 is a front elevation view of the first example retaining ring plier in a second configuration and operated to define a third spacing distance; and

FIG. 10 is a front elevation view of the first example retaining ring plier in the second configuration and operated to define a fourth spacing distance;

### DETAILED DESCRIPTION

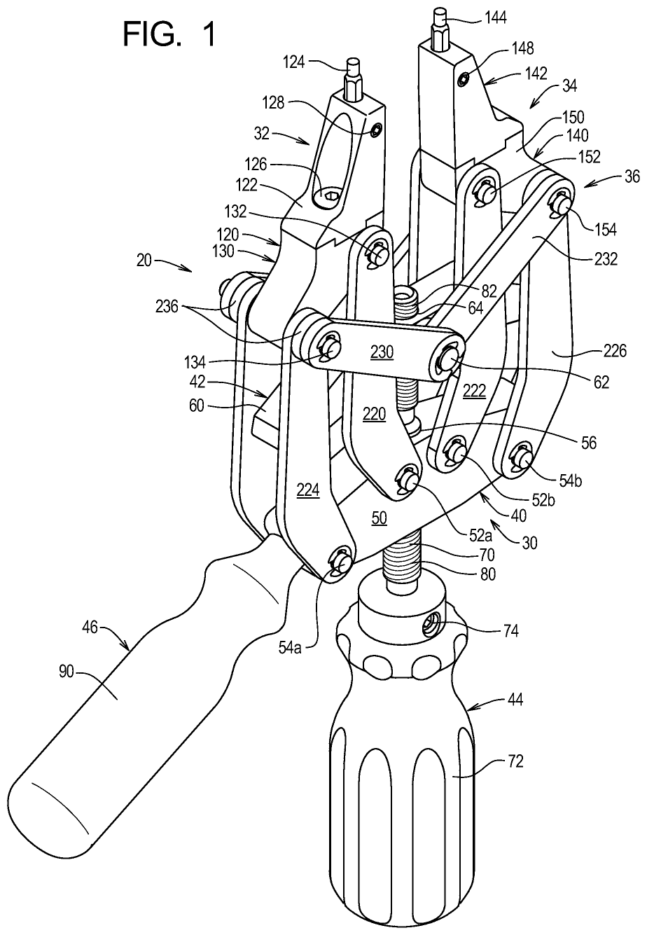

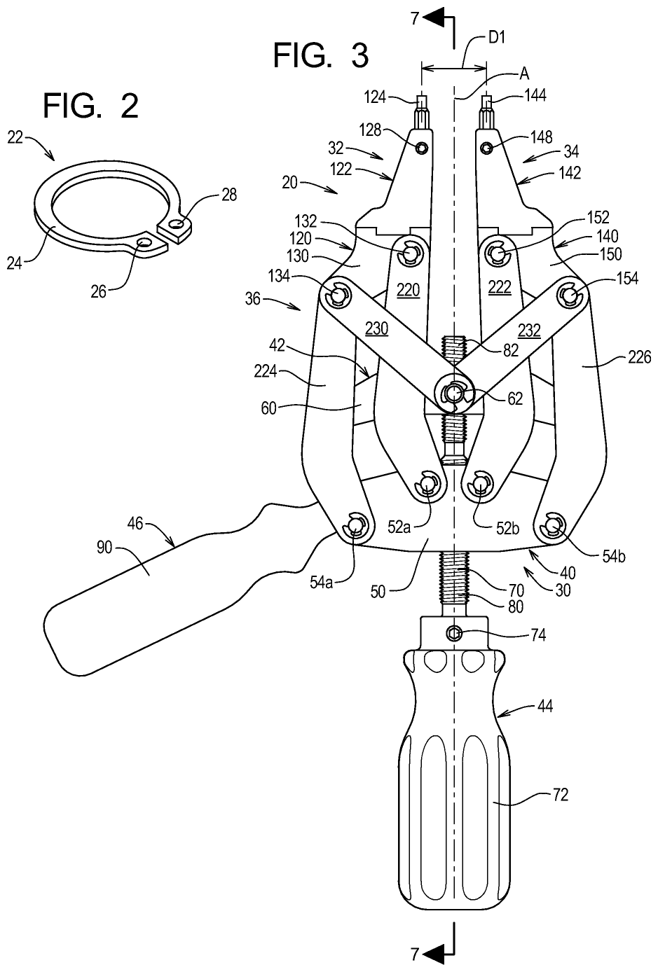

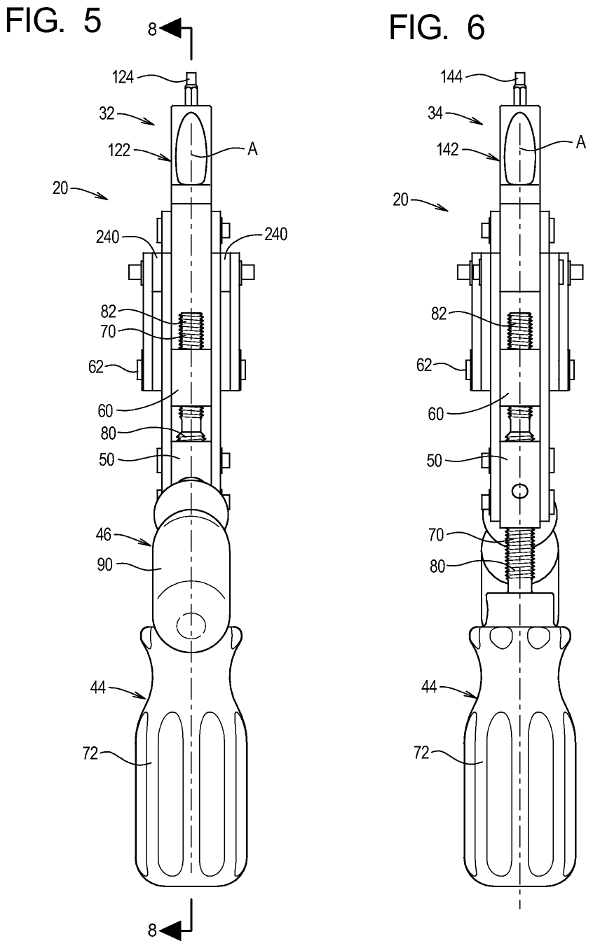

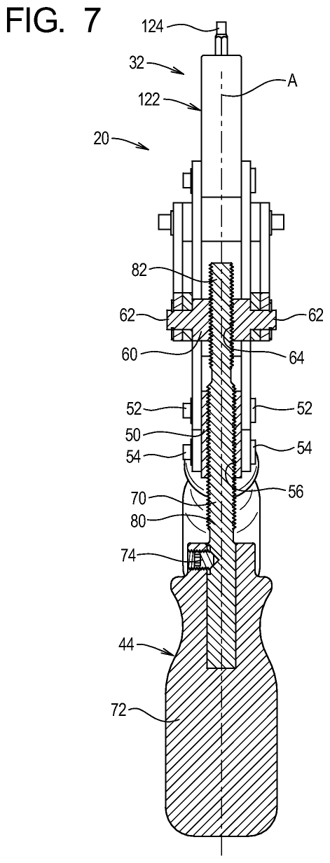

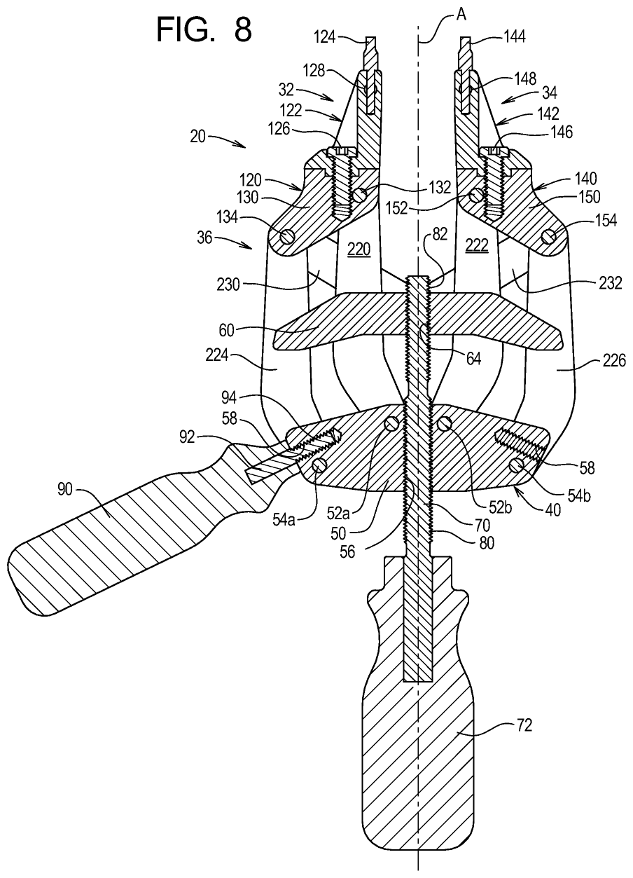

FIGS. 1 and 3-10 depict a first example retaining ring plier 20 constructed in accordance with, and embodying, the principles of the present invention. FIG. 2 illustrates a retaining ring 22 comprising a ring body 24 defining a first ring hole 26 and a second ring hole 28. The example retaining ring 22 is or may be conventional and will not be described beyond that extend helpful to a complete understanding of the present invention.

The first example retaining ring plier 20 comprises a drive system 30, a first tip assembly 32, a second tip assembly 34, and a linkage system 36. The drive system 30 is supported by the linkage system 36 such that operation of the drive system 30 displaces the first and second tip assemblies 32 and 34 towards and away from each other.

The example drive system 30 comprises a base assembly 40, a carrier assembly 42, a drive assembly 44, and, optionally, a guide handle assembly 46. The example base assembly 40 comprises a base member 50, base inner pins 52, base outer pins 54, a base threaded drive opening 56, and a guide handle support opening 58. The example carrier assembly 42 comprises a carrier member 60, drive pins 62, and a carrier member threaded drive opening 64. The example drive assembly 44 comprises a driver rod 70, a drive handle 72, and a drive fastener 74. The example drive rod 70 comprises a first threaded portion 80 and a second threaded portion 82. The example guide handle assembly 46 comprises a guide handle 90 and a guide pin 92 defining a connecting portion 94.

The example first tip assembly 32 comprises a first primary tip support assembly 120, a first secondary tip support assembly 122, a first tip member 124, a first support fastener 126, and a first tip fastener 128. The example first primary tip support assembly 120 comprises a first primary tip support member 130, inner first primary tip support pins 132 and outer first primary tip support pins 134. The example second tip assembly 34 comprises a second primary tip support assembly 140, a second secondary tip support assembly 142, a second tip member 144, a second support fastener 146, and a second tip fastener 148. The example second primary tip support assembly 140 comprises a second primary tip support member 150, inner second primary tip support pins 152 and outer second primary tip support pins 154.

The example linkage system 36 comprises first inner guide link members 220, second inner guide link members 222, first outer guide link members 224, and second outer guide link members 226, proximal drive link members 230, distal drive link members 232, and spacers 236.

To assemble the first example retaining ring plier 20, the drive handle 72 is secured to the drive rod 70 by the drive fastener 74. The first threaded portion 80 of the drive rod 70 is engaged with the base threaded drive opening 56 and the second threaded portion 82 of the drive rod 70 is engaged with the carrier threaded drive opening 64. The first and second threaded portions 80 and 82 are reversed relative to each other.

The example linkage system 36 is mirrored on both sides of the example retaining ring plier 20, and only one side of the example linkage system 36 will be described herein in detail. The first and second inner guide link members 220 and 222 are extended between the base inner pins 52a and 52b and the inner first and second primary support pins 132 and 152, respectively. The first and second outer guide link members 224 and 226 are extended between the base outer pins 54a and 54b and the outer first and second primary support pins 134 and 154, respectively. The proximal drive link members 230 are then extended between the outer second primary support pins 154 and the drive pins 62. The spacers 236 are next arranged on the outer first primary tip support pins 132. The distal drive members 232 are then extended between the outer first primary tip support pins 134 and the drive pins 62.

The first and second tip members 124 and 144 are next secured to the first and second secondary tip support members 122 and 142 by the first and second tip fasteners 128 and 148, respectively. The first and second secondary tip support members 122 and 142 are next secured to the first and second primary tip support members 130 and 150 by the first and second support fasteners 126 and 146, respectively.

If the guide handle assembly 46 is used, the guide handle 90 is secured to the guide pin 92, and the connecting portion 94 of the guide pin 92 is threaded into one of the guide handle support openings defined by the base member 50.

Because the first and second threaded portions 80 and 82 of the drive rod 70 are oppositely threaded, axial rotation of the drive rod 70 in a first rotation direction causes the base member 50 and carrier member 60 to be displaced away from each other along a drive axis A and axial rotation of the drive rod 70 in a second rotation direction causes the base member 50 and carrier member 60 to be displaced towards each other along the drive axis A.

Stated alternatively, axial rotation of the drive rod 70 in the first rotation direction causes the carrier member 60 to be displaced in a first drive direction along the drive axis A relative to the base member 50 and rotation of the drive rod in the second rotation direction causes the carrier member 60 to be displaced in a second drive direction along the drive axis A relative to the base member 50.

In turn, movement of the carrier member 60 relative to the base member 50 causes the carrier member 60 to on the first and second tip assemblies 32 and 34 through the drive link members 230 and 232 to move the drive tip assemblies 32 and 34 away from and towards each other with axial rotation of the drive rod 70 in the first and second directions, respectively. Stated alternatively, movement of the carrier member 60 in the first drive direction relative to the base member 50 causes the tip assemblies 32 and 34 to move towards the drive axis A and movement of the carrier member 60 in the second drive direction relative to the base member 50 causes the tip assemblies 32 and 34 to move away from the drive axis A. The carrier member 60 engages the and stiffens or prevents deflection of the arms 220, 222, 224, and 226 so the tool 20 is rigid during use.

The inner and outer guide link members 220, 222, 224, and 226 extend between the base member 50 and the primary tip support members 130 and 150 to ensure that the tip members 124 and 144 are substantially parallel as the drive tip assemblies 32 and 34 move away from and towards each other with axial rotation of the drive rod 70.

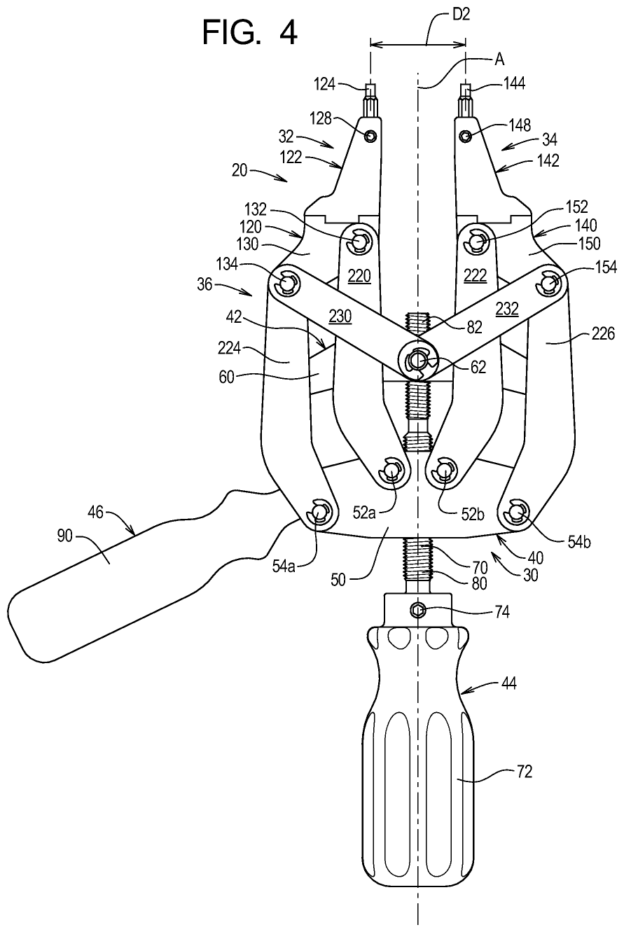

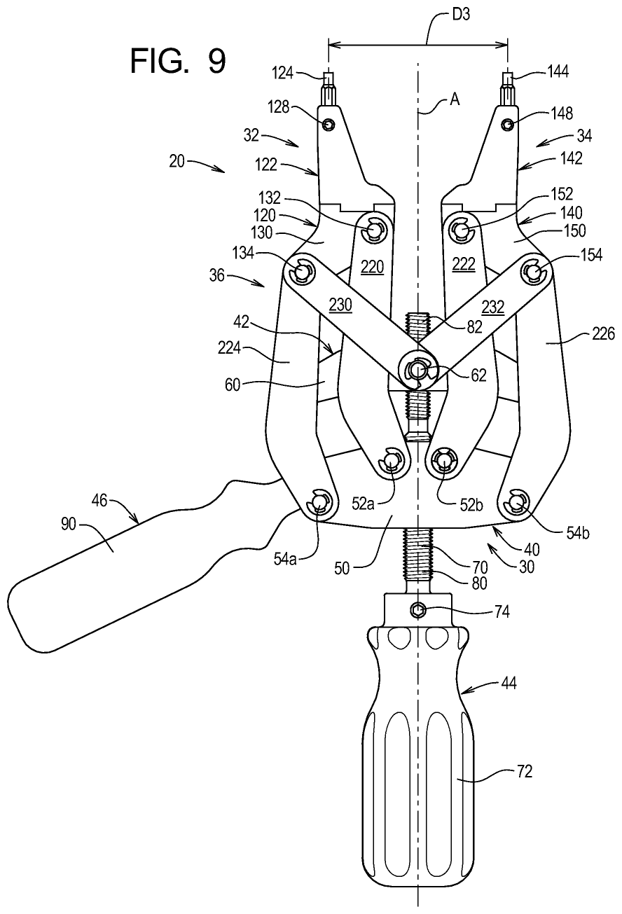

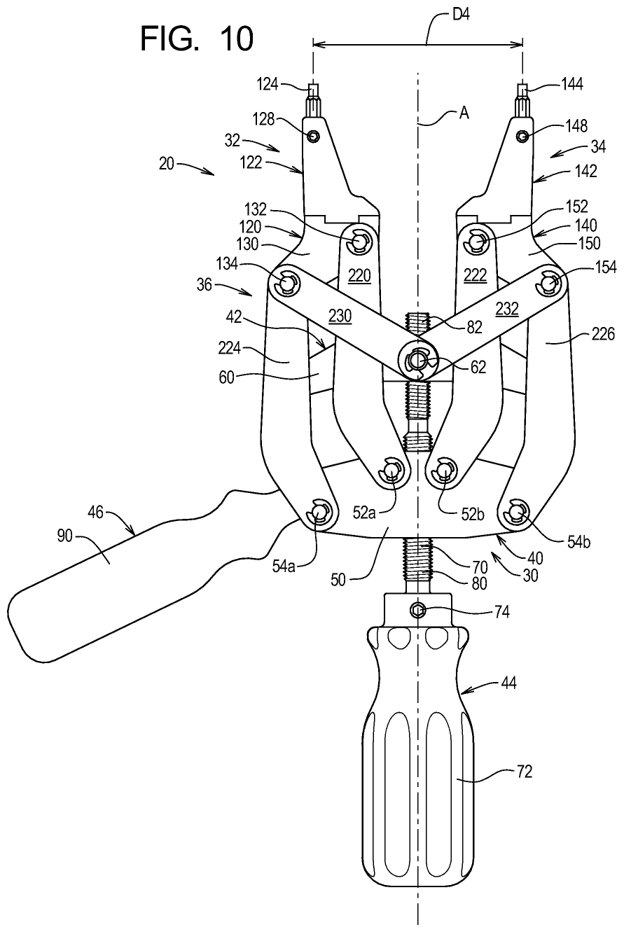

In FIGS. 3 and 4, the secondary tip support members 122 and 142 are in a first orientation relative to the primary tip support members 130 and 150. In FIGS. 9 and 10, the secondary tip support members 122 and 142 are in a second orientation relative to the primary tip support members 130 and 150. The first and second tip members 124 and 144 are closer together in the first orientation than in the second orientation. Accordingly, the tip members 124 and 144 may be moved, for example, between a narrow range defined by distances D1 and D2 in FIGS. 3 and 4 and a wider range defined by distances D3 and D4 in FIGS. 9 and 10.

In use, the drive rod 70 is arranged such that a distance between the tip members 124 and 144 is the same as a distance between the first and second ring holes 26 and 28 defined by the retaining ring 22. The tip members 124 and 144 are then inserted into the first and second ring holes 26 and 28. The drive rod 70 is next axially rotated in the first direction to increase the distance between the first and second ring holes 26 and 28. The retaining ring 22 is then arranged in a conventional manner in a desired orientation to a part to be retained. The drive rod 70 is then axially rotated in the second direction to decrease the distance between the first and second ring holes 26 and 28 to complete installation of the retaining ring 22.

What is claimed is:

1. A retaining ring plier comprising:
a drive system defining a drive axis and comprising
a base member defining a base drive opening,
a carrier member defining a carrier drive opening, and
a drive rod defining first and second surface portions, where the drive rod is arranged such that the first surface portion engages the base drive opening and the second surface portion engages the carrier drive opening;
a first tip;
a second tip; and
a linkage system comprising
a first drive link member extending between the carrier member and the first tip,
a second drive link member extending between the carrier member and the second tip,
at least one first guide link member extending between the base member and the first tip, and
at least one second guide link member extending between the base member and the second tip; wherein
axial rotation of the drive rod in a first rotation direction displaces the carrier member in a first drive direction relative to the base member;
displacement of the carrier member in the first drive direction displaces, through the first and second drive links, the first and second tips in a first tip direction relative to each other; and
the at least one first guide link and the at least one second guide link support the first and second tip assemblies to maintain a desired angular relationship between the first and second tips as the first and second tips are displaced relative to each other through the first and second drive links.

2. A retaining ring plier as recited in claim 1, in which:
axial rotation of the drive rod in a second rotation direction displaces the carrier member in a second drive direction relative to the base member;
displacement of the carrier member in the second drive direction displaces, through the first and second drive links, the first and second tips in a second tip direction relative to each other.

3. A retaining ring plier as recited in claim 1, in which the linkage system comprises:
at least two first guide link members extending between the base member and the first tip, and
at least two second guide link members extending between the base member and the second tip.

4. A retaining ring plier as recited in claim 1, further comprising a drive handle supported by the drive rod, where the drive handle facilitates axial rotation of the drive rod.

5. A retaining ring plier as recited in claim 1, further comprising a guide handle supported by the base member, where the guide handle facilitates manipulation of the retaining ring plier.

6. A retaining ring plier as recited in claim 1, further comprising:
a first tip assembly for supporting the first tip such that a location of the first tip relative to the drive axis is adjustable; and
a second tip assembly for supporting the second tip such that a location of the second tip relative to the drive axis is adjustable.

7. A retaining ring plier as recited in claim 1, further comprising:
a first tip assembly comprising first primary tip support assembly and a first secondary tip support assembly, where the first primary tip support assembly supports the first secondary tip support assembly and the first secondary tip support assembly supports the first tip; and
a second tip assembly comprising second primary tip support assembly and a second secondary tip support assembly, where the second primary tip support assembly supports the second secondary tip support assembly and the second secondary tip support assembly supports the second tip.

8. A method of installing retaining ring comprising the steps of:
providing a drive system defining a drive axis and comprising
a base member defining a base drive opening,
a carrier member defining a carrier drive opening, and
a drive rod defining first and second surface portions, where the drive rod is arranged such that the first surface portion engages the base drive opening and the second surface portion engages the carrier drive opening;
providing a first tip;
providing a second tip; and
providing a linkage system comprising
a first drive link member,
a second drive link member,
at least one first guide link member, and
at least one second guide link member; wherein
extending the first drive link member between the carrier member and the first tip;
extending the second drive link member between the carrier member and the second tip;
arranging the at least one first guide link member to extend between the base member and the first tip;
arranging the at least one second guide link member to extend between the base member and the second tip;
axially rotating the drive rod in a first rotation direction to displace the carrier member in a first drive direction relative to the base member such that displacement of the carrier member in the first drive direction displaces, through the first and second drive links, the first and second tips in a first tip direction relative to each other; and
arranging the at least one first guide link and the at least one second guide link to support the first and second tip assemblies such that a desired angular relationship is maintained between the first and second tips as the first and second tips are displaced relative to each other through the first and second drive links.

9. A method as recited in claim 8, in which:
axial rotation of the drive rod in a second rotation direction displaces the carrier member in a second drive direction relative to the base member;
displacement of the carrier member in the second drive direction displaces, through the first and second drive links, the first and second tips in a second tip direction relative to each other.

10. A method as recited in claim 8, in which the linkage system comprises at least two first guide link members and at least two second guide link members, where:
the at least two first guide link members are arranged to extend between the base member and the first tip, and
the at least two second guide link members are arranged to extend between the base member and the second tip.

11. A method as recited in claim 8, further comprising a drive handle supported by the drive rod, where the drive handle facilitates axial rotation of the drive rod.

12. A method as recited in claim 8, further comprising the step of supporting a guide handle from the base member such that the guide handle facilitates manipulation of the retaining ring plier.

13. A method as recited in claim 8, further comprising the steps of:
providing a first tip assembly for supporting the first tip such that a location of the first tip relative to the drive axis is adjustable; and
providing a second tip assembly for supporting the second tip such that a location of the second tip relative to the drive axis is adjustable.

14. A method as recited in claim 8, further comprising the steps of:
providing a first tip assembly comprising first primary tip support assembly and a first secondary tip support assembly;
arranging the first primary tip support assembly to support the first secondary tip support assembly;
arranging the first secondary tip support assembly to support the first tip;
providing a second tip assembly comprising second primary tip support assembly and a second secondary tip support assembly;
arranging the second primary tip support assembly to support the second secondary tip support assembly;
arranging the second secondary tip support assembly to support the second tip.

15. A retaining ring plier comprising:
a drive system defining a drive axis and comprising
a base member defining a base drive opening,
a carrier member defining a carrier drive opening, and
a drive rod defining first and second surface portions, where the drive rod is arranged such that the first surface portion engages the base drive opening and the second surface portion engages the carrier drive opening;
a first tip;
a second tip; and
a linkage system comprising
a first drive link member extending between the carrier member and the first tip,
a second drive link member extending between the carrier member and the second tip,
a pair of first guide link members extending between the base member and the first tip, and
a pair of second guide link members extending between the base member and the second tip; wherein
axial rotation of the drive rod in a first rotation direction displaces the carrier member in a first drive direction relative to the base member;
displacement of the carrier member in the first drive direction displaces, through the first and second drive links, the first and second tips in a first tip direction relative to each other; and
the pair of first guide links and the pair of second guide links support the first and second tip assemblies to maintain a desired angular relationship between the first and second tips as the first and second tips are displaced relative to each other through the first and second drive links.

16. A retaining ring plier as recited in claim 15, in which:
axial rotation of the drive rod in a second rotation direction displaces the carrier member in a second drive direction relative to the base member;
displacement of the carrier member in the second drive direction displaces, through the first and second drive links, the first and second tips in a second tip direction relative to each other.

17. A retaining ring plier as recited in claim 15, further comprising a drive handle supported by the drive rod, where the drive handle facilitates axial rotation of the drive rod.

18. A retaining ring plier as recited in claim 15, further comprising a guide handle supported by the base member, where the guide handle facilitates manipulation of the retaining ring plier.

19. A retaining ring plier as recited in claim 15, further comprising:
a first tip assembly for supporting the first tip such that a location of the first tip relative to the drive axis is adjustable; and
a second tip assembly for supporting the second tip such that a location of the second tip relative to the drive axis is adjustable.

20. A retaining ring plier as recited in claim 15, further comprising:
a first tip assembly comprising first primary tip support assembly and a first secondary tip support assembly, where the first primary tip support assembly supports the first secondary tip support assembly and the first secondary tip support assembly supports the first tip; and
a second tip assembly comprising second primary tip support assembly and a second secondary tip support assembly, where the second primary tip support assembly supports the second secondary tip support assembly and the second secondary tip support assembly supports the second tip.
